(19) United States
(12) Patent Application Publication
(10) Pub. No.: US 2008/0038543 A1
(43) Pub. Date: Feb. 14, 2008

(54) Sheet of Glass for Application of a Metallic Deposit and Resistant to a Coloration Possibly Induced by Such a Deposit

(75) Inventors: Sylvie Abensour, Montlignon (FR); Geraldine Duisit, Paris (FR); Catherine Goulas, Paris (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 10/589,736

(22) PCT Filed: Feb. 18, 2005
(86) PCT No.: PCT/FR05/50104

§ 371 Date: Sep. 17, 2007

(30) Foreign Application Priority Data
Feb. 19, 2004 (FR) 0450314

(51) Int. Cl. B32B 17/06; B32B 15/04; C03C 15/00

(52) U.S. Cl. 428/334; 428/432; 428/433; 428/434; 65/30.13

(57) ABSTRACT

Glass plate intended to constitute a plate-shaped product provided on at least part of at least one of its faces with a metal coating, the said plate being resistant to coloration due to at least one metal species Mⁿ⁺ the said metal coating, which species, under the conditions in which the product is manufactured and/or used, would be liable to migrate into the glass from its surface and then undergo reduction to the species M⁰ responsible for the coloration, characterized in that it includes, at least on the surface and on at least one face sensitive to coloration, a composition capable of limiting or preventing the said migration and/or the said reduction of the one or more Mⁿ⁺ species.

The present invention relates to a glass plate intended to constitute a plate-shaped product provided on at least part of at least one of its faces with a metal coating, the said plate being resistant to coloration due to at least one metal species Mⁿ⁺ of the said metal coating, which species, under the conditions in which the product is manufactured and/or used, would be liable to migrate into the glass from its surface and then undergo reduction to the species M⁰ responsible for the coloration.

The metal species that may induce undesirable coloration are in particular Ag, Cu and Au.

Such undesirable colorations appear, owing to interactions between the components of the glass and these metal species, either during manufacturing treatments carried out on the products, more particularly when these treatments include heating steps that encourage the migration of the species responsible for the undesirable coloration in the glass, and also throughout the ageing and use of the products, in particular when the use involves a high temperature and/or electron bombardment.

The plate-shaped products having received a metal coating that are subject to the risks of glass coloration are called “substrates” in the electronics field. These are for example the faceplates of television screens and computer screens, and, in general, emissive displays, such as plasma display panels, electroluminescent displays and cold-cathode or field-emission displays.

As other products, mention may be made of flat lamps, index-graded microlenses and heated rear windows for motor vehicles.

Current emissive displays comprise a glass substrate on which very thin transparent layers of mixed indium tin oxide (ITO) have been deposited, followed by very thin, and also transparent, silver layers constituting a second array of electrodes, these electrodes lying within a dielectric.

It has been observed that these substrates have a tendency to develop a yellow coloration, which contributes to degrading the image quality, especially by reducing its luminous intensity and by modifying its colours, and which gives the display a dirty and not very presentable appearance. This yellowing phenomenon is attributed to the fact that the Ag⁺ ions migrate into the glass, where they are reduced to the form of colloidal Ag⁰ particles, which absorb light within the wavelength range from 390 to 420 nm.

This coloration anomaly may appear at various times:
during manufacture of the display, if it was necessary to carry out a high-temperature treatment, the rise in temperature encouraging the migration of Ag⁺ions;
during use for example, when the temperature rise or electron bombardment will further encourage coloration; and
by normal ageing of the display, the Ag⁺ ions migrating further over the course of time, especially when a voltage is applied.

The same problems as with displays arise with flat lamps, microlenses and rear windows.

There is therefore a need to have a glass plate as defined above that does not suffer coloration under the conditions in which the final products, such as displays, are manufactured and used.

The present invention provides a solution to this problem.

For this purpose, the glass plate according to the present invention is characterized by the fact that it includes, at least on the surface and on at least one face sensitive to coloration, a composition capable of limiting or preventing the said migration and/or the said reduction of the one or more Mⁿ⁺ species.

In accordance with one particular feature of the glass plate according to the present invention, the said plate may thus be produced so as to present, on the surface and on the face or faces sensitive to coloration and at least over a depth to which the Mⁿ⁺ species is capable of migrating, a quantity of reducing agent capable of reducing the Mⁿ⁺ species, this quantity being at most equal to 1.40×10⁻⁷ mol/cm², in particular at most equal to 7×10⁻⁸ mol/cm² and advantageously at most equal to 3.5×10⁻⁸ mol/cm² when the Mⁿ⁺ metal species is Ag⁺.

The reducing agent is chosen from elements having several oxidation states, such as Fe, S, Sn, Sb and mixtures of these elements. It is preferred to choose Fe, S and/or Sn.

The protocol for this measurement is given below.

A metallic silver layer about 400 nm in thickness is deposited on the glass sheet by cathode sputtering. Next, the sheet is heated in air for one hour at 600° C. then treated with nitric acid so as to remove the surface silver layer.

The profile of the silver in the subsurface layer of the glass is measured by SIMS: the profile has a peak corresponding to the reduction of the silver by the reducing agent. The amount of reducing agent, in mols per cm², is obtained by measuring the silver content integrated over the thickness of the glass corresponding to the silver peak.

This measurement expresses the quantity of reducing agent on the surface of the glass that must not be exceeded, so that the Mⁿ⁺ ions cannot be reduced to the point of inducing unacceptable coloration. A glass obtained by the float process has, on its face in contact with the bath of molten tin, a higher content of reducing agent than on the opposite face. However, it would not be enough merely to apply the layer containing the metal liable to migrate onto this second, less coloration-sensitive, face.

It should also be mentioned that the said quantity of reducing agent according to the invention is that of the glass as produced without an additional polishing step that would allow the surface layer having the desired quantity of reducing agent to be reached.

In accordance with another particular feature of the glass plate according to the present invention, the said plate is provided, on the coloration-sensitive face or faces, with a layer acting as a barrier to the migration of the Mⁿ⁺ species, to which barrier layer continuous or discontinuous functional layers are capable of adhering, and which barrier layer is unable to react chemically with the said functional layers so as to degrade the properties thereof.

In particular, the barrier layer may be chosen from layers based on one or more metal oxides, such as SiOₓC_{y} (x=0-2; y=0-1, the limits being excluded), MgO, ZnO and SnₓZn_{y}O_{z} (x and y each having a non-zero value; z=2x+y), and the layers based on AlN and Si₃N₄/AlN mixtures.

Preferably, the barrier layer is non-conducting. Optionally, an additional layer of SiO₂, SiOC or Si₃N₄ different from the barrier layer may be applied to the barrier layer before the first functional layer is deposited.

As examples of functional layers, mention may be made of TiO₂ anti-soiling layers and ITO, F:SnO₂, Sb:SnO and Al:ZnO conductive layers.

In accordance with another particular feature of the present invention, the alkaline-earth metal content includes barium only in a limited proportion, that is to say in a quantity such that the BaO content does not exceed 2% by weight of the glass composition.

In accordance with yet another particular feature of the glass plate of the present invention, the said plate has an alkali metal content under conditions that ensure what is called a “mixed alkali” effect. Preferably, the alkali metals are lithium, sodium and potassium. In particular, the alkali metals are sodium and potassium that are present in the form of their corresponding oxides, Na₂O and K₂O, in molar quantities that satisfy the following relationship: 0.35≦K₂O/K₂O+Na₂O≦0.65.

In accordance with other particular features of the glass plate according to the present invention, the said plate has an alumina weight content not exceeding 3% and/or a silica weight content not exceeding 65%.

If the glass plate has a coloration-sensitive surface region, which has a composition different from that of the core with the quantity of reducing agent as defined above or is provided with a preferably non-conducting barrier layer, also as defined above, the surface layer capable of limiting or preventing the migration or reduction of the one or more Mⁿ⁺ species advantageously has a thickness of less than 100 μm, preferably less than 50 μm and especially less than 20 μm.

At least in the two cases that have just been mentioned, the glass plate may be produced in the form of a ribbon obtained by the float process on a bath of molten metal, such as a bath of tin, that coloration-sensitive face of the glass in the finished product being the one on the opposite side to that which was in contact with the tin.

In accordance with yet another particular feature of the glass plate according to the present invention, the said plate has a lower annealing temperature, also called the strain-point temperature, corresponding to the temperature at which the glass has a viscosity of the order of 10^{14.5} poise, which is above 550° C., in particular above 580° C.

In accordance with yet another particular feature of the glass plate according to the present invention, if the said plate is produced on a bath of molten tin, its composition is chosen so as to allow it to be produced under conditions that discourage the migration of Sn²⁺ or H₂ into the atmosphere face of the glass ribbon. To do this, the H₂ content of the N₂/H₂ reducing atmosphere above the bath is lowered relative to the normal working conditions, in order to decrease the SnS saturation vapour pressure and to limit the diffusion of H₂ into the atmosphere face. The temperature of the bath and that of the glass are also lowered relative to the normal working conditions, the sulphate content of the glass being advantageously lowered relative to the normal working conditions in order to reduce the SnS content.

In particular, at least one of the following conditions is satisfied:

viscosity of the glass corresponding to log η=3.5, at a temperature not exceeding 1230° C., preferably between 1180 and 1220° C. (η being expressed in dPa.s);
temperature of the bath not exceeding 1220° C.;
temperature at which the glass is poured onto the bath of molten tin not exceeding 1280° C.;
H₂ content in the atmosphere of the bath 7% by volume or less.

In accordance with other particular features of the glass plate according to the present invention, the said plate contains at least one element capable of colouring the glass with a colour that is complementary to the colour at risk owing to the diffusion of Mⁿ⁺, for example Co²⁺.

A glass having the following composition satisfies the present invention, the proportions by weight of the constituents being the following:

| | |
|---|---|
| SiO₂ | 65-75% |
| Al₂O₃ | 0-3% |
| ZrO₂ | 2-7% |
| Na₂O | 0-8% |
| K₂O | 2-10% |
| CaO | 3-10% |
| MgO | 0-5% |
| SrO | 3-12% |
| BaO | 0-2% |
| Other oxides | 0-2%. |

The subject of the present invention is also a process for manufacturing a coloration-resistant glass plate in a float process in which it floats on a bath of molten tin, characterized in that the float process is carried out under the following conditions:
viscosity of the glass corresponding to log η=3.5, at a temperature not exceeding 1230° C., preferably between 1180 and 1220° C. (η being expressed in dPa.s);
temperature of the bath not exceeding 1220° C.;
temperature at which the glass is poured onto the bath of molten tin not exceeding 1280° C.;
H₂ content in the atmosphere of the bath 7% by volume or less.

The present invention also relates to the application of a glass plate as defined above, or obtained by the process as defined above, to the manufacture of plate-shaped glass products that have received metal coatings liable to generate a coloration during treatments, especially at high temperature, during their manufacture and/or during use, owing to interactions between the components of the glass itself and these metals, in particular to the manufacture of emissive displays, such as plasma display panels, electroluminescent screens and field-emission displays, flat lamps, index-graded microlenses and rear windows for motor vehicles.

The following examples illustrate the present invention, without however limiting the scope thereof.

### EXAMPLES 1 To 3

These examples illustrate the effect of the temperature at which the glass is poured and of the H₂ content in the bath of molten tin on the coloration of the final glass.

Conventional soda-lime-silicate glasses were produced in the form of a ribbon by floating on a bath of molten tin under the conditions defined below. These glasses had the chromatic coordinates L*, a* and b* given below, these being measured, for a thickness of 6 mm, under illuminant D₆₅ taking the CIE 1931 calorimetric reference observer.

| | Ex. 1 | Ex. 2 | Ex. 3 |
|---|---|---|---|
| Pour temperature (° C.) | 1269 | 1330 | 1330 |
| H₂ content (%) | 6 | 0 | >6 |
| L* | 94.7 | 94.5 | 94.5 |
| a* | −2.01 | −2.44 | −2.47 |
| b* | 5.59 | 6.63 | 7.31 |

This table shows that the glasses of Examples 1 and 2 according to the invention have a lower b* value than that of the glass of Example 3 (comparative example), this reduction corresponding to a less pronounced yellow coloration. The lower pour temperature of the glass (Example 1) or the lower H₂ content in the bath of molten tin (Example 2) enables the yellowing of the glass to be reduced.

### EXAMPLES 4 AND 5

These examples illustrate the influence of the glass composition on the surface content of reducing agent.

A metallic silver layer about 400 nm in thickness was deposited on a glass sheet by cathode sputtering. After treatment at 600° C. in air for one hour, the face bearing the silver coating was treated with nitric acid.

The glass according to the invention (Example 4) had the following composition, in % by weight:

| | |
|---|---|
| SiO₂ | 67.5 |
| Al₂O₃ | 0.5 |
| ZrO₂ | 2.0 |
| Na₂O | 4.0 |
| K₂O | 8.0 |
| CaO | 9.0 |
| SrO | 9.0. |

The quantity of reducing agent, measured by SIMS as indicated above, was 2.89×10⁻⁸ mol/cm². This quantity was 1.40×10⁻⁷ mol/cm² for a conventional soda-lime-silicate glass obtained by floating on a bath of molten tin and treated under the same conditions (Example 7).

1. Glass A glass plate intended to constitute a plate-shaped product provided on at least part of at least one of its faces with a metal coating, said plate being resistant to a coloration due to at least one metal species Mⁿ⁺ of the said metal coating, which species, under the conditions in which the product is manufactured and/or used, would be liable to migrate into the glass from its surface and then undergo reduction to a species M⁰ responsible for the coloration, characterized in that said plate includes, at least on the surface and on at least one face sensitive to coloration, a composition capable of limiting or preventing said migration and/or said reduction of one or more Mⁿ⁺ species.

2. The plate according to claim 1, characterized in that said plate is produced so as to present, on the surface and on the face or faces sensitive to coloration and at least up to a depth to which the Mⁿ⁺ species is capable of migrating, a quantity of reducing agent capable of reducing the Mⁿ⁺ species, this quantity being at most equal to 1.40×10⁻⁷ mol/cm² when the Mⁿ⁺ metal species is Ag⁺.

3. The plate according to claim 2, characterized in that said reducing agent is chosen from elements having several oxidation states, said elements being selected from the group consisting of Fe, S, Sn, Sb and mixtures of these elements.

4. The plate according to claim 2, characterized in that said quantity of reducing agent is at most equal to 7×10⁻⁸ mol/cm².

5. The plate according to claim 1, characterized in that said plate is provided, on the coloration-sensitive face or faces, with a layer acting as a barrier to the migration of the Mⁿ⁺ species, to which barrier layer continuous or discontinuous functional layers are capable of adhering, and which barrier layer is unable to react chemically with the said functional layers so as to degrade the properties thereof.

6. The plate according to claim 5, characterized in that the barrier layer is chosen from layers based on one or more metal oxides, selected from the group consisting of SiOₓC_{y} wherein x=0-2 and y=0-1, the limit being excluded, MgO, ZnO and SnₓZn_{y}O_{z} wherein x and y each having have a non-zero value and z=2x+y, and layers based on AlN and Si₃N₄/AlN mixtures.

7. The plate according to claim 5, characterized in that said layer is non-conducting.

8. The plate according to claim 1, characterized in that the alkaline-earth metal content includes barium only in a limited proportion, the BaO content not exceeding 2% by weight of the glass composition.

9. The plate according to one claim 1, characterized in that it has an alkali metal content under conditions that ensure what is called the “mixed-alkali” effect.

10. The plate according to claim 9, characterized in that the alkali metals are selected from the group consisting of lithium, sodium and potassium.

11. The plate according to claim 10, characterized in that the alkali metals are sodium and potassium which are present in the form of their corresponding oxides, Na₂O and K₂O, in molar quantities that satisfy the following relationship:
0.35≦K₂O/K₂O+Na₂O≦0.65.

12. The plate according to claim 1, characterized in that it has an alumina weight content not exceeding 3%.

13. The plate according to claim 1, characterized in that it has a silica weight content not exceeding 65%.

14. The plate according to claim 1, characterized in that a surface layer capable of limiting or preventing the migration or reduction of the one or more Mⁿ⁺ species has a thickness of less than 100 μm.

15. The plate according to claim 1, characterized in that said plate is produced in the form of a ribbon obtained by a float process on a bath of molten metal, and that the coloration-sensitive face of the glass in the finished product is the one on the opposite side to that which was in contact with the molten metal.

16. The plate according to claim 1, characterized in that it has a strain-point temperature above 550° C.

17. The plate according to claim 15, said plate being produced on a bath of molten tin, characterized in that its composition is chosen so as to allow it to be produced under conditions that discourage the migration of Sn²⁺ or H₂ into the atmosphere face of the glass ribbon, the H₂ content of the N₂+H₂ reducing atmosphere above the bath being lowered relative to the normal working conditions, in order to decrease the SnS saturation vapour pressure and the temperature of the bath and that of the glass being lowered relative to the normal working conditions, the sulphate content of the glass being advantageously lowered relative to the normal working conditions in order to reduce the SnS content.

18. The plate according to claim 17, characterized in that at least one of the following conditions is satisfied:
the viscosity of the glass corresponding corresponds to log η=3.5 at a temperature not exceeding 1230° C.;
the temperature of the bath of molten tin does not exceed 1220° C.;
the temperature at which the glass is poured onto the bath of molten tin does not exceed 1280° C.; and
the H₂ content in the atmosphere of the bath is 7% by volume or less.

19. The plate according to claim 1, characterized in that it contains at least one element capable of colouring the glass with a colour that is complementary to the colour at risk owing to the diffusion of Mⁿ⁺.

20. The plate according to claim 1, having the following composition, the proportions by weight of the constituents being as follows:
SiO₂: 65-75%
Al₂O₃: 0-3%
ZrO₂: 2-7%
Na₂O: 0-8%
K₂O : 2-10%
CaO: 3-10%
MgO: 0-5%
SrO: 3-12%
BaO: 0-2%
Other oxides: 0-2%.

21. A process for manufacturing a coloration-resistant glass plate, as defined in claim 1, in a float process in which it floats on a bath of molten tin, characterized in that the float process is carried out under the following conditions:
the viscosity of the glass corresponds to log η=3.5 at a temperature not exceeding 1230° C.;
the temperature of the bath of molten tin does not exceed 1220° C.;
the temperature at which the glass is poured onto the bath of molten tin does not exceed 1280° C.; and
the H₂ content in the atmosphere of the bath is 7% by volume or less.

22. A method of utilizing a glass plate as defined in claim 1, in the manufacture of emissive displays, plasma display panels, electroluminescent screens, field-emission displays, flat lamps, index-graded microlenses and rear windows for motor vehicles.
